(19) United States
(12) Patent Application Publication
(10) Pub. No.: US 2007/0043752 A1
(43) Pub. Date: Feb. 22, 2007

(54) Disparate network model synchronization

(75) Inventors: George Zacharla, Cary, NC (US); Graham Howard Middleton, Durham, NC (US); Amish Shah, Apex, NC (US); Pradeep K. Singh, Arlington, VA (US); Shibu Yoosef Vachery, Cary, NC (US)

Correspondence Address: ROBERT M. MCDERMOTT, ESQ., 1824 FEDERAL FARM ROAD, MONTROSS, VA, 22520, US

(73) Assignee: OPNET Technologies, Inc.

(21) Appl. No.: 11/501,389

(22) Filed: Aug. 9, 2006

Related U.S. Application Data
(60) Provisional application No. 60/709,771, filed on Aug. 19, 2005.

(51) Int. Cl. G06F 7/00

(52) U.S. Cl. 707/101

(57) ABSTRACT

Changes to the source network model are captured in a database schema independent fashion, and an update manager broadcasts the changes to a registered client as and when the changes occur. Alternatively, the update manager can be queried, and in response, returns a summary of changes corresponding to criteria specified in the query. The client assesses the change summary to determine whether to request the detailed information corresponding to one or more of the reported changes in the change summary. A combination of both approaches may include, for example, regularly broadcasting a change summary and responding to specific subsequent requests. To facilitate an efficient scheme for identifying and filtering changes of interest, associative change records are provided, wherein the devices or components of the network that are associated with each change are identified. To facilitate selective time based retrieval, each change record includes a date-time stamp.

This application claims the benefit of U.S. Provisional Patent Application 60/709,771, filed 19 Aug. 2005.

### BACKGROUND AND SUMMARY OF THE INVENTION

This invention relates to the field of network analysis, management, and support, and in particular to a method and system for synchronizing the information contained in a variety of different models of the network.

The management of complex networks includes the use of various tools to analyze and assess the performance of the network, to predict and avoid future performance degradation, to forecast and schedule maintenance and support activities, and so on. Each of these tools relies upon a description, or model, of the system, including the attributes of the elements of the network that are relevant to the particular tool.

Because of the demands placed upon typical networks, changes are often and continually made; equipment is added or removed, attributes associated with the equipment are adjusted, connections are rerouted, and so on. Whenever such changes occur, each of the aforementioned models of the system may or may not need to be updated, depending upon the particular change.

To effectively manage changes to a network, a single ‘source’ model of the network is typically maintained, and each change to the network is recorded. Ideally, each of the models used by the various tools associated with the network is derived from the source model, so that each tool remains ‘up to date’, or ‘synchronized’ to the source model.

FIG. 1 illustrates a block diagram of a conventional system for synchronizing multiple network models 150a-n to a source model 130. A change compiler 120 receives change records 110 and updates the source model 130 accordingly. Alternatively, or optionally, the source model may be derived from the actual network and compared to a prior version of the source model to create the change records. In like manner, the data used to update the source model 130 may be obtained from traps from network devices, syslog messages, network management platforms that redirect messages they receive, and so on; optionally, changes may be detected by periodically polling network devices or network management platforms for data. In the context of this disclosure, the change records 110 symbolize any changes to the source model 130, regardless of the particular scheme used to generate the records 110, or the particular form or format of the record.

An update manager 180 is responsible for distributing the changes to clients that are configured to synchronize their local tool models 150a-n to the information contained in the source model 130. The update manager 180 is also responsible for responding to requests for changes within a time period, and for providing details of a network model element if requested. Any of a variety of techniques can be employed to assure this synchronization. At one client A, the update manager 180 provides a copy 130a of the changed source model 130; while at another client B, the update manager 180 provides a copy 110b of the change records 110. At client B, a change compiler 120b compiles the changes to update a copy 130b of the network model. At client N, the client has direct access to the source model 130. Each of the clients A, B, . . . N process their version 130a, 130b, 130 of the source network model 130 via a tool translator 140a, 140b, 140n, to produce a model 150a, 150b, 150n that is in a form that is suitable for the particular tool 160a, 160b, 160n. Because each tool model is based on a network model that is derived from the same change records 110, the tool models are assured to be synchronized to the master source model 130.

The conventional synchronization system of FIG. 1, however, is inefficient, and prone to failure and/or misuse. In a moderately complex network, there may be many changes recorded per day. If these changes are broadcast to all of the client systems as they occur, each client must either replace or augment its version of the network model with the change, then process the changed model to create its updated tool model. The inefficiency derives from the fact that not all changes to source model are relevant to each tool, and therefore quite often the recreated tool model 150 does not differ from the prior version of the model in any appreciable/relevant manner. Because of the high likelihood of a ‘false alarm’ (i.e., receipt of a network model change that does not produce a relevant tool model change), or other inherent inefficiencies associated with the updating process, many users come to ignore the changes that are broadcast from the update manager, or disable the automatic updating features of the system.

To decrease the load placed on the client systems caused by the broadcast of each change, the update manager may be configured to broadcast accumulated changes periodically, such as daily, or weekly, or aperiodically, such as at every “Nth” change. While this reduces the load on the client system, it also introduces periods of non-synchronized models, and, to the users of some tools, this lack of synchronization may be unacceptable.

It is an objective of this invention to reduce the number of irrelevant change notifications sent to clients. It is a further objective of this invention to allow a user to control the methods used to synchronize network models to provide an appropriate balance between the processing at each client and the periods of non-synchronization.

These objectives, and others, are achieved by a system and method that provides a network change notification scheme that facilitates client interaction with the change notification process to reduce the likelihood of unnecessary change communication and processing. Changes to the source network model are captured in a database schema independent fashion, and an update manager broadcasts the changes to a registered client as and when the changes occur. Alternatively, the update manager can be queried, and in response, returns a summary of changes corresponding to criteria specified in the query. The client assesses the change summary to determine whether to request the detailed information corresponding to one or more of the reported changes in the change summary. A combination of both approaches may include, for example, regularly broadcasting a change summary and responding to specific subsequent requests. To facilitate an efficient scheme for identifying and filtering changes of interest, associative change records are provided, wherein the devices or components of the network that are associated with each change are identified. To facilitate selective time based retrieval, each change record includes a date-time stamp.

### BRIEF DESCRIPTION OF THE DRAWINGS

The invention is explained in further detail, and by way of example, with reference to the accompanying drawings wherein:

FIG. 1 illustrates an example block diagram of a prior art network model update management system.

FIG. 2 illustrates an example block diagram of a network model update management system in accordance with this invention.

FIG. 3 illustrates an example data structure of a network model, with example changes.

FIG. 4 illustrates an example data structure of a network model update management system in accordance with this invention.

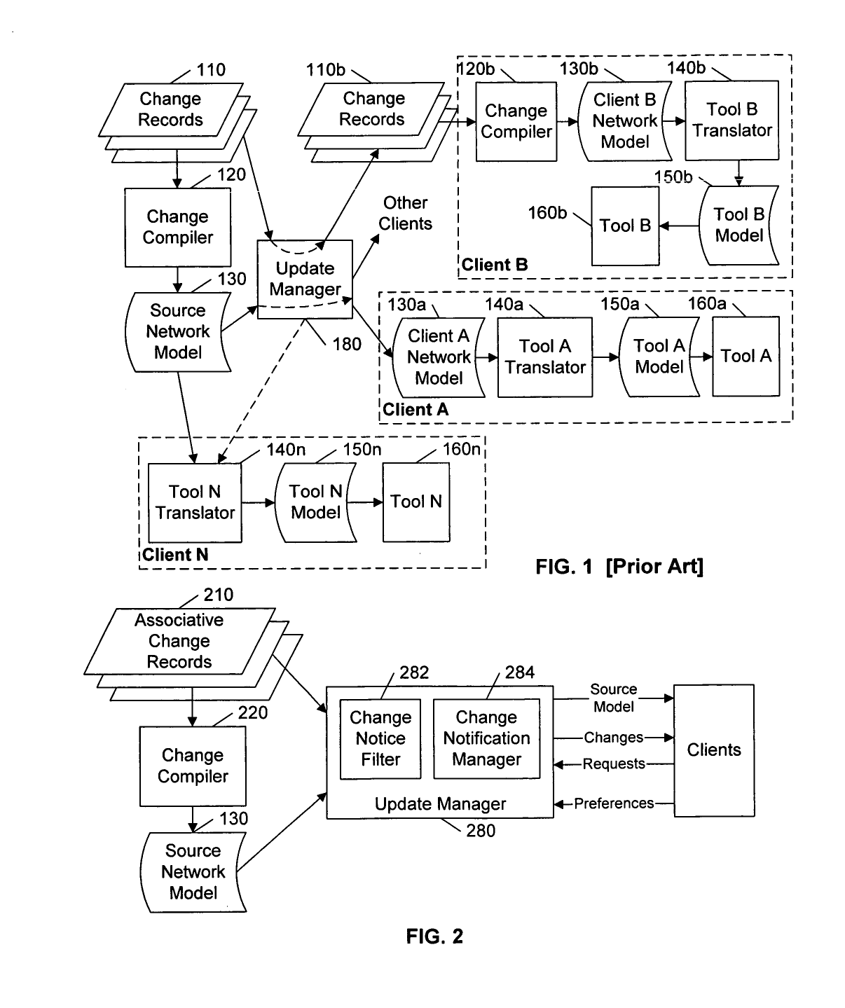

Throughout the drawings, the same reference numerals indicate similar or corresponding features or functions. The drawings are included for illustrative purposes and are not intended to limit the scope of the invention.

### DETAILED DESCRIPTION

In the following description, for purposes of explanation rather than limitation, specific details are set forth such as the particular architecture, interfaces, techniques, etc., in order to provide a thorough understanding of the concepts of the invention. However, it will be apparent to those skilled in the art that the present invention may be practiced in other embodiments, which depart from these specific details. In like manner, the text of this description is directed to the example embodiments as illustrated in the Figures, and is not intended to limit the claimed invention beyond the limits expressly included in the claims. For purposes of simplicity and clarity, detailed descriptions of well-known devices, circuits, and methods are omitted so as not to obscure the description of the present invention with unnecessary detail.

As noted above, the invention includes the communication of a change summary, from which each client can determine whether to request the details of the change for processing at the client. The client's determination of whether to request additional information will generally be dependent upon the tools or tasks that are performed by the client based on the network model. For example, a client may be a manager of a subset of the network, and may prefer to only receive changes that affect equipment within the manager's control. In other applications, a client may prefer to only receive changes to the routing tables of all or some routers in the network, or to receive changes to all nodes except those that match one or more specified criteria.

In accordance with another aspect of this invention, different versions of the change summary are provided, based on the individual client's preferences, so that the client can predefine the set of changes that are likely to be of interest. For example if the client is only interested in a portion of the network, the client can register this preference, and a filter is created to create a change summary that only includes the portion of interest.

For ease of reference, the terms ‘relevant’ and ‘irrelevant’ are used hereinafter to distinguish the changes that a client might need to maintain synchronization with the network model within the clients sphere of interest/responsibility. For example, with regard to the aforementioned manager of a subset of a network, changes to nodes within the subset would be relevant changes, as might be changes to nodes that directly communicate with the subset, while all other changes would be deemed irrelevant changes, as far as that manager/client is concerned.

To facilitate the determination of the relevancy of each change to each client, ‘associative’ change records are provided, wherein each device or node that is associated with the change is identified. Typically, the association is hierarchical. For example, nodes contain interfaces, interfaces contain sub-interfaces; aggregate interfaces bundle interfaces, links bundle interface end-points, and so on. Conventionally, the hierarchy is defined by the content of data records. The upper-level elements include pointers to their lower-level elements, which include pointers to their lower-level elements, and so on.

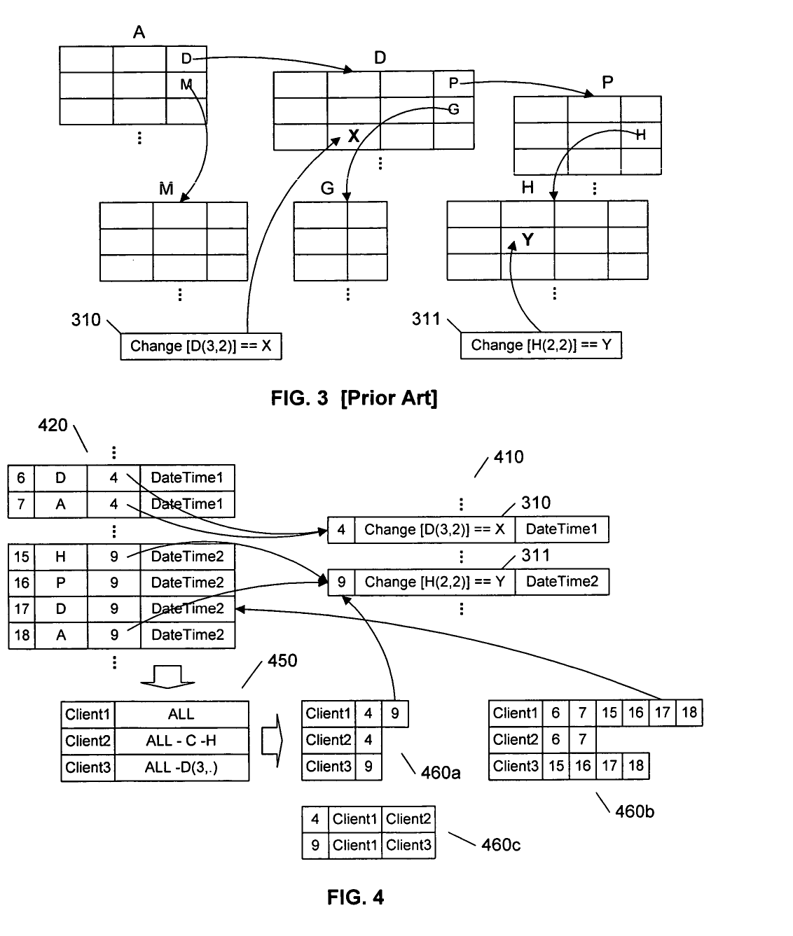

FIG. 3 illustrates an example of a conventional hierarchy of data records, corresponding to ‘elements’ A, D, G, H, M, and P of the network model. FIGS. 3 and 4 are provided as simple examples to facilitate understanding of the principles of this invention; the actual structure of the network elements and change records will be dependent upon the particular embodiment of the network model. Regardless of the particular embodiment, the application of the principles of this invention to actual network elements and change records will be evident to one of ordinary skill in the art in view of these examples.

The set of data records for element A in FIG. 3 illustrate two records that include pointers to elements D and M. The set of data records for element D includes pointers to elements P and G; and the data records of P includes a pointer to element H. Element A may represent, for example, the entire network; element D may represent a node in the network; element P may represent an interface at the node; element H may represent a sub-interface; and so on.

Two changes 310 and 311 are illustrated in FIG. 3. The change at 310 replaces the second entry of the third record of element D (D(3,2)) with a value “X”. In an actual network, the change would generally be more descriptive, and would refer to the entries by object or attribute names, rather than indices to the data records, such as “Change ‘bit rate’ at ‘interface downtown’ at ‘node nyc’ to ‘X’”. The use of indices and subscripts are used herein for ease of reference. The other change 311 changes the second entry in the second record of element H (H(2,2)) to a value

As can be seen, when a change to the network is reported, the change is specific to the element to which it applies (D(3,2); H(2,2)). Because the upper-level elements refer to the lower-level elements, a simulation of the upper-level element will reflect the effects of the changes to the lower-level elements, because the hierarchy is processed in a top-down manner to effect the simulation of the element. Other tools that use the hierarchical source network model will similarly process the model in a top-down manner, down to whatever level the tool requires to perform its task, and therefore changes at each level between the uppermost level and the tool's lowest level will be included in the processing of the upper-level elements.

Because the processing of each element that is linked to a changed element will automatically reflect the change to the element, a hierarchical, or otherwise indirectly linked, data structure is well suited for effective change propagation and change management. Conversely, however, a linked data structure is poorly suited for selective change processing. In a conventional hierarchical data structure, for example, a change to a lower-level data record is not reflected in the data record of its upper-level element, and requires a processing of each upper-level data record to determine which lower-level changes may have an effect on each upper-level element. That is, in the example of FIG. 3, there is no indication at element A that a change has occurred at element D, nor an indication at element A that a change has not occurred at element M. In like manner, there is no indication at elements D or P that a change has occurred at element H.

In accordance with this aspect of this invention, changes are recorded in an associative manner, such that the change is recorded for each network element that is associated with the changed item. In the example of FIG. 3, element A, being at the top of the hierarchy is associated with each of the lower level elements; element D, on the other hand, is not associated with element M; element P is not associated with elements M or G; and so on.

In FIG. 4, the example changes 310 and 311 are illustrated as they may appear in a conventional set of change records 410. Change 310 is shown as the fourth change in the set, and change 311 is shown as the ninth change in the set; each change typically includes a date-time stamp or other indication of when the change occurred.

In accordance with this aspect of the invention, a set of associative change records 420 is also provided. These change records, as discussed above, identify each element that is associated with each change. Record 6 in these records identifies network element D being associated with change number 4 of the change records 410, corresponding to change 310. Record 7 identifies network element A as also being associated with this fourth change record. In like manner, records 15-18 identify elements H, P, D, and A, respectively, being associated with change number 9 of the change records 410. By providing this set of associative change records, each network element that is affected by each change is immediately identifiable.

In accordance with a further aspect of this invention, the date-time stamp or other indicator of when each change has occurred is also included in the associative change records 420, to facilitate data base queries such as: “List all changes that have affected element D since noon yesterday”; or “List all changes that have affected element H between midnight and 8 am today”.

The associative change records can also be used as a means for notifying clients of changes, so that each client can selectively choose which changes to download and/or, if the changes are included with the associative change records, selectively choose which changes to process for updating the client's local models.

In a preferred embodiment, changes are classified by sub-types for each type of network element. For example, changes associated with an interface element may be classified by changes to the basic interface, changes to sub-interfaces, and changes to aggregate interfaces. In like manner, changes to a service element may include these interface change types, as well as node and link sub-types. Time based performance changes, such as utilization and flow changes may be classified by time duration or time range.

The sub-types facilitate the formation of queries from the clients, and responses from the update manager. In a preferred embodiment, the query is formulated using the subtype and the object identifier (typically a number) of that model element. The change framework also uses the same sub type to broadcast change information associated with the corresponding model element to all registered clients. The formulation of the query and the broadcast of the change is performed using identical XML formats, comprising a header and a body section. The header contains the meta information about the change itself (model element, object id, attribute of the object, etc.). The body contains the details of the change itself, optionally including change history.

The client uses the meta information to identify the corresponding network model element in the client network model. Typically, each client maintains a map of client network model element identifiers to source network model element identifiers. On establishing the identity of the client network model element, the client extracts the details of the change itself and applies it to update the client network model element.

For network model data that is time varying such as utilization metrics on interfaces and end-to-end flows, the client obtains a summary of the most recent data imported into the source network model from the meta information embedded in the XML format of the change record. The client extracts the compressed time varying data in the body of the XML change record and adds this information into the client network model.

This query framework also supports the retrieval of change summaries. Change summaries list summary information of the addition, deletion and modification of model elements. The query can then simply request the list of all object identifiers with their corresponding sub types that have changed in a given time range.

In accordance with a further aspect of this invention, and referring to FIG. 2, each client may optionally provide ‘preferences’ to the update manager 280, and the update manager 280 can use these preferences to filter the changes, or the change notifications, that are provided to each client, or each set of clients. For example, a client may prefer to only receive changes that are associated with a subset of the network, wherein the subset may be defined logically, structurally, geographically, functionally, and so on, or the client may prefer to only receive changes of a particular type. For example, different parameters or attributes in the records may be classified as relating to administration, operation, performance, and so on, and one client may, for example, indicate a preference for not receiving administrative or performance changes, while another may indicate a preference for receiving operational information pertaining to routers within a given geographic area, and so on. In like manner, changes may be characterized by type, such as ‘addition’, ‘deletion’, ‘modification’, and so on.

In a preferred embodiment of this invention, the update manager 280 is configured to receive each client's preferences, and the change notice filter 282 is configured to transform these preferences into filters that serve to identify potentially relevant changes to each of the clients, based on these preferences. The change notification manager 284 correspondingly notifies each client of potentially relevant changes, based on these filters, as illustrated in FIG. 4.

Data set 450 in FIG. 4 illustrates filters associated with three clients. Client1 has indicated a preference for receiving all changes. Client2 has indicated a preference for receiving all changes except (as indicated by the minus “−” sign) changes to elements C and H. Client3 has indicated a preference for receiving changes associated with elements B, and D, but not changes related to the third record of element D (D(3,.)). Although FIG. 4 illustrates these elements and entries as a conventional linked-list, one of ordinary skill in the art will recognize that the form of the embodiment of the filters and their processing is independent of the principles of this invention. For example, elements A, D, P, M G, and H may be thought of as model element types; in Object Oriented Programming these would be “classes”. A specific row in the “A” table would be a “model element instance”; thus, for example, D(3,.) is a model element instance and D is the model element type.

As noted above, the user's preferences are not restricted to identifying particular elements in the network model. Preferably, the update manager 280 is configured to accept user preferences in a variety of forms, and processes these preferences to produce one or more filters that are configured to effectively and efficiently identify changes that may be relevant to the client, based on the expressed preferences. One of ordinary skill in the art will recognize that any of a variety of techniques may be used to identify client preferences and to create filters based on such preferences, including rule-based systems, learning systems, neural networks, and others.

As illustrated in FIG. 4, the set of filters 450 facilitate the creation of change notification reports 460a, or 460b. Report 460a is a ‘change’ report, and report 460b is an ‘associative change’ report. In report 460a, each of the clients that may be interested in each change is identified; in report 460b, each of the clients that may be interested in each associative change is identified. That is, the illustrated records of report 460a indicate that change 4 is of potential interest to client1 and client2, and change 9 is of potential interest to client1 and client3. The same information is presented in an alternative form in table 460c, ordered by change number.

The report of the associative changes 460b is provided to inform clients of changes from a hierarchical perspective. In this example, client1 is notified of associative changes 6, 7, 15, 16, 17, and 18 in dataset 420, thereby informing client1 that changes have occurred that are associated with elements D, A, H, P, D, and A, respectively; in like manner, associative changes of likely interest to client2 include associative changes 6, and 7. As in the report 460c, the report 450b could be presented in alternative form, ordered by associative change number.

One of ordinary skill in the art will recognize that the aforementioned preference and filtering process is not limited to a binary relevant/irrelevant characterization of each change for each client. Optionally, for example, the client may specify a variable level of interest/relevance, ranging from high priority to low priority. In such an embodiment, the client's priority would be indicated in the change notification report, to allow the client to determine the importance of processing each change. Optionally or alternatively, the update manager may be configured to communicate high priority changes immediately to the client, and to communicate the lower priority changes on a routine, periodic basis.

In like manner, a client may choose to query change records over a given time range, rather than receiving each change as it occurs. In such situations, model attributes and elements may have changed their values multiple times in a given time range, and the client may only be interested in receiving the latest value. For example, the sysUpTime on a node changes continually. The change is captured as a change record each time this information is imported into the database at the granularity of actual import of the data to the system model. When a client requests change records over a time range that spans multiple imports, it is possible to collapse the earlier change records with regard to a given attribute in favor of the most recent change within that time range, to reduce the amount of data transferred to the client. In a preferred embodiment, multiple changes to a parameter are collapsed by default to the latest value within the requested change period, although the client is provided the option of disabling this collapsing process for any or all of the requested changes.

By identifying each of the network elements affected by each change to the source network model, and/or by identifying potential changes of interest to each client, the publication and distribution of change notifications to assure proper synchronization of local models to the source network model can be substantially improved.

In a broadcast, or ‘push’, environment, a client registers to listen for change broadcasts from the source network model. The client may choose to receive the change orders directly, corresponding each change of interest in report 460a, or may choose to receive a change record summary that carries information of associative change records to higher level elements and to the element itself, corresponding to each associative change of interest in report 460b. In the first approach, if a client receives a broadcast of change records, the client applies each change in the record by locating the corresponding model element identified in the change record, thereby synchronizing the client's model. In the second approach, if the client receives a broadcast of the associative change record summary, it may send a second request to the update manager for the current information associated with selected model elements specified in the associative change record summary.

As noted above, the client may choose either option. This choice is generally dependent upon the particular client and network. If many changes occur regularly, the broadcast of the change records may overwhelm network resources. In such a case, it would likely be preferable to broadcast an associative change record summary. On the other hand, if the changes are few and far between, the broadcast of an associative change record summary can lead to excessive calls back from the client for information that may not have changed.

In a preferred embodiment, and particularly for large-scale networks, the client is provided a third option wherein the update manager selects whether to broadcast the change records or the associative change summary, based on the number of changes, network loading, and so on.

In a ‘brute-force’ approach, the client queries for the high level model elements that have had associated changes. Given that the network model is hierarchical and that the change records in the source network model captured for lower level model elements are propagated to change records for the higher level model elements, as discussed above, a client can query for a change summary that lists the changes to the highest level containers in the source network model. For example, a network model element such as a node contains other network model elements such as interfaces and sub interfaces. The addition or deletion of interfaces, the changes to one or more interface configurations is reflected in a change record that indicates that the node itself has changed. The client can simply request the list of all the nodes that have “changed” in the source network model. Note that the requested information is the “deep” version of the network model element. The “deep” version of the network model element contains the attributes of the element and all of the model elements contained within that element (recursively). On obtaining the change summary consisting of nodal network model elements that have changed, the client can simply delete its current representations of those nodes in the client network model taking care to resolve all interconnections to that node. It can then query the source network model for the current information on the “changed” nodes.

An ‘optimized’ approach is similar to the Brute-force approach. However, the client obtains the detailed change summary that contains the list of all model elements that have changed in a given time range. The client then requests the current state of the changed model elements from the source network model. Note that in this approach, the requested information for each network model element that has changed is “shallow”. The “shallow” version of the network model element contains information about that element alone and does not contain information about the network model elements within it. As described above, the client applies these changes incrementally to the client network model.

A client may choose to implement network model synchronization using a combination of the above approaches. In this hybrid approach, the client registers to listen for changes and applies the changes as described earlier. This approach is adequate when there is zero loss in the broadcast change records. However network latencies, losses and breakdowns can lead to missed packets. In this situation, the client will need to resynchronize with the source network model using the Pull Synchronization Model. In the hybrid approach the Pull Synchronization model can be applied as often as necessary so long as care is taken to maintain the time stamps of synchronization with the source network model.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts is intended to be required unless specifically indicated; and

i) the term “plurality of” an element includes two or more of the claimed element, and does not imply any particular range of number of elements; that is, a plurality of elements can be as few as two elements, and can include an immeasurable number of elements.

I claim:

1. A method comprising:
identifying a change to a first network element in a source network model,
determining one or more second network elements in the source network model that are associated with the first network element,
creating one or more associative change records that associates the change to each of the first network element and the second network elements, and
communicating information related to the change to one or more clients, based on the associative change records.

2. The method of claim 1, wherein
the one or more second network elements are associated with the first network element in a hierarchical manner.

3. The method of claim 1, wherein
communicating the information related to the change includes broadcasting the associative change records to the one or more clients.

4. The method of claim 1, wherein
the change includes a corresponding time of the change, and
the one or more associative change records include the time of the change.

5. The method of claim 1, including
responding to one or more requests from the one or more clients.

6. The method of claim 5, wherein
the change includes a corresponding time of the change,
at least one of the one or more requests includes a time-range, and
communicating the information related to the change is based on the time-range and the time of the change.

7. The method of claim 1, including
receiving a change-notification preference from at least one client, and wherein
communicating the information related to the change to the at least one client is based on the change-notification preference.

8. The method of claim 1, including
defining change-notification preferences for the one or more clients, and
identifying select clients for receiving the information related to the change based on the change-notification preferences.

9. The method of claim 1, wherein
the associative change records are provided in a XML form.

10. The method of claim 1, wherein
communicating the information related to the change includes responding to one or more requests from the one or more clients, and
the one or more requests and the associative change records are provided in a common XML form.

11. The method of claim 1, including
identifying multiple changes to the first network element,
processing the multiple changes to create a set of recent changes, and
creating the one or more associative change records based on the set of recent changes.

12. The method of claim 11, wherein
the processing of the multiple changes includes filtering of at least one of:
redundant changes, and
superceded changes.

13. The method of claim 1, including associating a priority to the change, and
communicating the information related to the change based on the priority.

14. The method of claim 1, wherein
the information related to the change includes the associative change records.

15. The method of claim 1, wherein
the information related to the change includes the change to the first network element.

16. A system comprising:
a source network model, and
an update manager that is configured to:
identify a change to a first network element in the source network model,
determine one or more second network elements in the source network model that are associated with the first network element,
create one or more associative change records that associates the change to each of the first network element and the second network elements, and
communicate information related to the change to one or more clients, based on the associative change records.

17. The system of claim 16, wherein
the one or more second network elements are associated with the first network element in a hierarchical manner.

18. The system of claim 16, wherein
the update manager is configured to communicate the information related to the change by broadcasting the associative change records to the one or more clients.

19. The system of claim 16, wherein
the change includes a corresponding time of the change, and
the one or more associative change records include the time of the change.

20. The system of claim 16, wherein
the update manger is configured to respond to one or more requests from the one or more clients.

21. The system of claim 25, wherein
the change includes a corresponding time of the change,
at least one of the one or more requests includes a time-range, and
the update manager is configured to communicate the information related to the change based on the time-range and the time of the change.

22. The system of claim 16, wherein
the update manager is configured to:
receive a change-notification preference from at least one client, and
communicate the information related to the change to the at least one client based on the change-notification preference.

23. The system of claim 16, wherein
the update manager is configured to:
receive change-notification preferences for the one or more clients, and
identify select clients for receiving the information related to the change based on the change-notification preferences.

24. The system of claim 16, wherein
the update manager is configured to provide the associative change records in a XML form.

25. The system of claim 16, wherein
the update manager is configured to:
receive one or more requests from the one or more clients, and
communicate the information related to the change in response to the one or more requests, and
the one or more requests and the associative change records are provided in a common XML form.

26. The system of claim 16, wherein
the update manager is configured to:
identify multiple changes to the first network element,
process the multiple changes to create a set of recent changes, and
create the one or more associative change records based on the set of recent changes.

27. The system of claim 31, wherein
the update manager is configured to process of the multiple changes by filtering of at least one of:
redundant changes, and
superceded changes.

28. The system of claim 16, wherein
the update manager is configured to
associate a priority to the change, and
communicate the information related to the change based on the priority.

29. The system of claim 16, wherein
the information related to the change includes the associative change records.

30. The system of claim 16, wherein
the information related to the change includes the change to the first network element.

31. A computer program embodied on a computer media, which, when executed by a processor, causes the processor to:
identify a change to a first network element in the source network model,
determine one or more second network elements in the source network model that are associated with the first network element,
create one or more associative change records that associates the change to each of the first network element and the second network elements, and
communicate information related to the change to one or more clients, based on the associative change records.

32. The computer program of claim 31, wherein
the one or more second network elements are associated with the first network element in a hierarchical manner.

33. The computer program of claim 31, wherein
the update manager is configured to communicate the information related to the change by broadcasting the associative change records to the one or more clients.

34. The computer program of claim 31, wherein
the change includes a corresponding time of the change, and
the one or more associative change records include the time of the change.

35. The computer program of claim 31, which causes the processor to
respond to one or more requests from the one or more clients.

36. The computer program of claim 35, wherein
the change includes a corresponding time of the change,
at least one of the one or more requests includes a time-range, and
computer program causes the processor to communicate the information related to the change based on the time-range and the time of the change.

37. The computer program of claim 31, which causes the processor to
receive a change-notification preference from at least one client, and
communicate the information related to the change to the at least one client based on the change-notification preference.

38. The computer program of claim 31, which causes the processor to:
receive change-notification preferences for the one or more clients, and
identify select clients for receiving the information related to the change based on the change-notification preferences.

39. The computer program of claim 31, which causes the processor to
provide the associative change records in a XML form.

40. The computer program of claim 31, which causes the processor to
receive one or more requests from the one or more clients, and
communicate the information related to the change in response to the one or more requests, and
the one or more requests and the associative change records are provided in a common XML form.

41. The computer program of claim 31, which causes the processor to
identify multiple changes to the first network element,
process the multiple changes to create a set of recent changes, and
create the one or more associative change records based on the set of recent changes.

42. The computer program of claim 41, which causes the processor to process of the multiple changes filtering of at least one of:
redundant changes, and
superceded changes.

43. The computer program of claim 31, which causes the processor to
associate a priority to the change, and
communicate the information related to the change based on the priority.

44. The computer program of claim 31, wherein
the information related to the change includes the associative change records.

45. The computer program of claim 31, wherein
the information related to the change includes the change to the first network element.
